(19) United States
(12) Patent Application Publication
(10) Pub. No.: US 2023/0026104 A1
(43) Pub. Date: Jan. 26, 2023

(54) METHOD FOR REFUELLING A VEHICLE

(71) Applicant: Robert Bosch GmbH, Stuttgart (DE)

(72) Inventor: Helerson Kemmer, Vaihingen (DE)

(21) Appl. No.: 17/786,600

(22) PCT Filed: Nov. 12, 2020
(86) PCT No.: PCT/EP2020/081841

§ 371 Date: Jun. 17, 2022

(30) Foreign Application Priority Data
Dec. 17, 2019 (DE) 10 2019 219 826.0

(51) Int. Cl. F17C 5/00

(52) U.S. Cl. CPC F17C 5/007; F17C 2270/0184; F17C 2221/012; F17C 2265/065; F17C 2227/0346

(57) ABSTRACT

The invention relates to a method for refuelling a vehicle (60) or an autonomous vehicle (60). At least one hydrogen tank (10) accommodating gaseous hydrogen is fitted in the vehicle (60). The method comprises the following method steps: The vehicle (60) drives into a refuelling area (24). A refuelling operation (28; 78, 80, 82) is performed on the vehicle (60). Then, the temperature of the contents of the at least hydrogen tank (10) is checked (30). If a temperature (74) of the tank contents of the at least one hydrogen tank (10) exceeds a temperature limit value (32), the vehicle (60) is transferred to a cooling down area (36). There, the tank temperature (44) is checked a second time following a cooling down phase. The tank pressure is checked (48) if the tank temperature (74) lies below a temperature limit value. If the tank pressure (76) in the at least one hydrogen tank (10) is below a tank pressure limit value, the vehicle (60) is transferred to the refuelling area (24) to continue refuelling; if the tank pressure (76) is in the tank pressure limit range, refuelling is halted (52).

### BACKGROUND OF THE INVENTION

The present invention relates to a method for refuelling a vehicle, in particular an autonomous vehicle, with gaseous hydrogen, the vehicle having at least one hydrogen tank integrated in the vehicle. The invention also relates to the use of the method for refuelling an autonomous or non-autonomous vehicle with fuel-cell drive and at least one hydrogen tank.

Fuel cell systems based on a gaseous fuel, such as for example hydrogen, are considered to be a mobility concept of the future, since they only emit water as exhaust gas and make rapid refuelling times possible. Owing to its low density, the storage of hydrogen in the vehicle is a challenge. Various types of tank have become established, with the gaseous hydrogen today generally being stored under pressures between 350 bar and 700 bar, in particular in the case of mobile applications. The refuelling operation is standardized by international standards, such as for example SAE TIR J2601. According to this standard, the gaseous hydrogen is pre-cooled at a filling station to a temperature of −40° C. Hydrogen heats up when it expands. This is also the reason why the temperature of the vehicle tank or its tank contents increases during a refuelling operation. In order to prevent overheating, which is accompanied by softening of the carbon fiber bonds or of a metal microstructure, the hydrogen is pre-cooled to −40° C. and a flow of hydrogen from the filling station to the tank is restricted. The pre-cooling requires an energy input of at least 0.5 kWh per kilogram of hydrogen, which amounts to about 1.5% of the energy content. Furthermore, when there is low utilization of the filling station and/or on summer days, this energy input may exceed the amount of energy of the refuelled hydrogen. That leads to increased operating costs for maintaining hydrogen filling stations, which in turn leads to increased cost prices for supplying the end user with hydrogen.

### SUMMARY OF THE INVENTION

The invention proposes a method for refuelling with gaseous hydrogen a vehicle or an autonomous vehicle which has at least one hydrogen tank integrated in the vehicle, the following method steps being carried out:

a) driving the vehicle into a refuelling area,
b) performing a refuelling operation on the vehicle,
c) performing a first temperature check on the tank contents of the at least one hydrogen tank,
d) transferring the vehicle to a cooling-down area if a temperature of the tank contents of the at least one hydrogen tank exceeds a temperature limit value,
e) performing a second temperature check,
f) performing a tank pressure check if the temperature of the tank contents of the at least one hydrogen tank lies below a temperature limit value,
g) making a switch to method step a) if the tank pressure of the at least one hydrogen tank lies below a tank pressure limit value,
h) bringing refuelling to an end if the tank pressure reaches the tank pressure limit value.

The method proposed by the invention allows refuelling of a fuel-cell-operated vehicle with fuel, which is preferably gaseous hydrogen, to be performed during a time period during which the vehicle is generally parked and not being used.

In a further refinement of the concept on which the invention is based, according to method step b), the refuelling operation takes place during the night with non-precooled gaseous hydrogen. If non-precooled hydrogen is used in the method proposed by the invention, the hydrogen filling station can be designed in a simplified manner to the extent that production of the hydrogen refuelling station does not require the expenditure involved in providing precooling to temperatures down to −40° C.

In a development of the method proposed by the invention, for performing method step b), the connection of the vehicle to a robotic refuelling device takes place in an automatic or semiautomatic manner.

In a development of the method proposed by the invention, in an advantageous way according to method step c), the refuelling operation according to method step c), a first tank temperature check may be performed, the refuelling operation being interrupted and the vehicle transferred to a cooling-down area if heating up of the tank contents of the at least one hydrogen tank reaches a first temperature value, for example 85° C. This takes place for example autonomously, without requiring intervention on the part of a driver or a supervisor.

In a development of the method proposed by the invention, in the cooling-down area according to method step d), active or passive measures for cooling down the tank contents of the at least one hydrogen tank are initiated. The active cooling-down measures may comprise cooling of the at least one hydrogen tank by a vehicle cooling circuit; an active cooling-down measure may also be provided by activation of an internal blower of the vehicle, or there is the possibility of connecting the vehicle to a blower located outside the vehicle, i.e. to an external blower, so that the tank contents of the at least one hydrogen tank can be significantly cooled down.

In a development of the method proposed by the invention, after cooling down of the tank contents of the at least one hydrogen tank, for example to ambient temperature, according to method step d), and performing a second tank check, according to method step e), the vehicle can once again be autonomously transferred to the refuelling area, so that a renewed refuelling operation can be performed according to method step b).

Once the further refuelling operation has been completed, when a first temperature value of for example 85° C. of the tank contents of the at least one hydrogen tank is reached, the vehicle is transferred to the cooling-down area, where the tank contents is once again subjected to cooling down by active or passive cooling-down measures. In the present context, for example natural convection or heat conduction is a passive cooling-down measure.

In the method proposed by the invention, method steps a) to e) are successively carried out, a tank pressure check being performed until the tank pressure for example at ambient temperature lies in the range of the tank pressure limit value; then, the refuelling of the vehicle having at least one hydrogen tank is completed.

Furthermore, the procedure proposed by the invention may be discontinued after a defined time period (“timeout”) or when a time of day has passed or when an instruction that the vehicle is to be used with immediate effect is received, even if the end of refuelling has not been reached.

The invention additionally relates to the use of the method for refuelling an autonomous or non-autonomous vehicle with fuel-cell drive and at least one hydrogen tank, in which gaseous hydrogen can be stored.

### Advantages of the Invention

The method proposed by the invention can advantageously achieve the effect that the cost prices of gaseous hydrogen for the end user are reduced. There is no longer any need for precooling of the gaseous hydrogen at hydrogen filling stations, as a result of which the investment costs and operating costs that are required for such filling stations are reduced. This leads to a further reduction in the costs of the gaseous hydrogen for the end user. The solution proposed by the invention allows an increase in the range of a fuel-cell-operated vehicle to be achieved. This is so because, when the method proposed by the invention is applied, it is possible that the refuelling of the fuel-cell-operated vehicle does not have to be ended when the maximum tank pressure of for example 875 bar has been reached for the first time. This pressure at a temperature of 85° C. corresponds to the nominal pressure of 700 bar at 20° C. This positive pressure is allowed in the refuelling process with the inclusion of precooling, which means that the tank is designed and approved for this pressure.

When the method proposed by the invention is applied, the tank pressure is about 700 bar, for example after a third cooling-down cycle and correspondingly accompanying cooling down of the tank contents. If a further cycle follows after that, the tank pressure of the 700 bar reached can be increased again to for example 875 bar—at an ambient temperature to be expected as a maximum of for example 45° C., as is reached in summer. In this way, the filling of the at least one hydrogen tank is increased by a factor of (875 bar*293 K/318 K)/700 bar=1.15, whereby a corresponding increase in the range by about 15% could be achieved.

A further, additional increase in the range of a fuel-cell-operated vehicle would be possible in the case of the calculation given above if a lower maximum ambient temperature than 318 K, i.e. 45° C., were assumed. Furthermore, the solution according to the invention can achieve the effect that the customer no longer has to drive to the filling station, which increases the convenience. Furthermore, operating personnel are no longer needed at the filling stations and the filling stations can be designed in a more space-saving manner.

### BRIEF DESCRIPTION OF THE DRAWINGS

Embodiments of the invention are explained in more detail on the basis of the drawings and the following description.

In the drawings:

FIGS. 1.1-1.4 show design variants of hydrogen tanks,

FIG. 2 shows a flow diagram of the method proposed by the invention,

FIG. 3 shows an active cooling measure on a vehicle by means of a vehicle cooling circuit,

FIG. 4 shows an active cooling measure with an external blower and

FIG. 5 shows a tank temperature profile and also a tank pressure profile during refuelling on the basis of the method proposed by the invention.

### DETAILED DESCRIPTION

In the following description of the embodiments of the invention, the same or similar elements are denoted by the same reference signs, without the description of these elements being repeated in individual cases. The figures only provide a schematic representation of the subject matter of the invention.

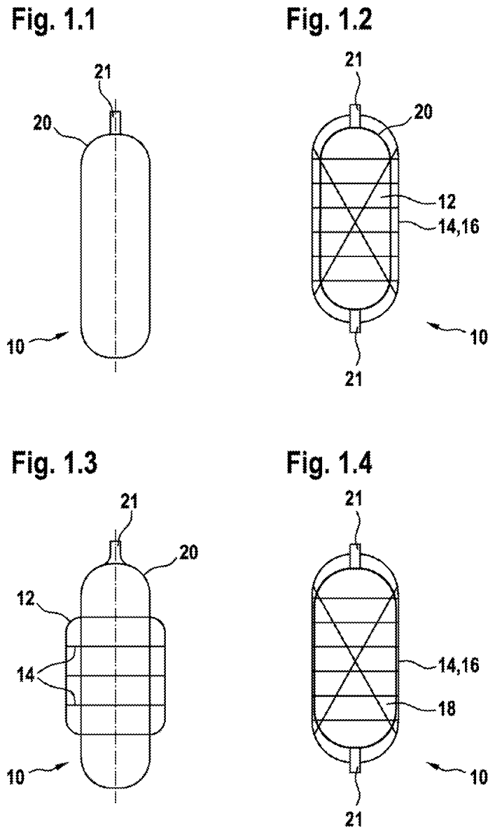

FIGS. 1.1-1.4 show design variants of a hydrogen tank 10 with a casing 12. The casing 12 is provided by a mesh structure 14, which is produced from a composite material 16. The hydrogen tank 10 shown in FIG. 1 can be filled with gaseous hydrogen up to a pressure of 700 bar. In a further design variant of a hydrogen tank 10, it likewise has a casing 12, which is provided by a mesh structure 14. The hydrogen tank 10 is produced from a polymer material 18, the mesh structure 14 from a composite material 16. FIG. 1.1 shows a hydrogen tank 10 with a shell 20 of metal and a connection 21; FIG. 1.3 shows a hydrogen tank 10 with a shell 20 of metal and a casing 12, provided by a mesh structure 14, and also a connection 21.

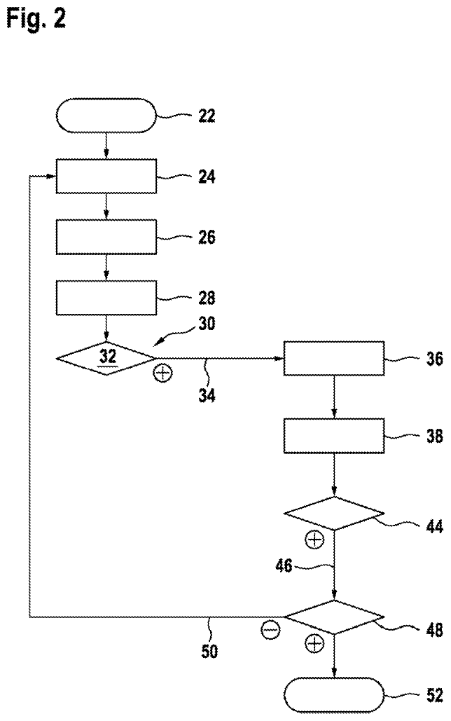

FIG. 2 shows a flow diagram of the method proposed by the invention for refuelling a vehicle. At the beginning of refuelling 22, the vehicle reaches a refuelling area 24. There, the vehicle is connected to a refuelling device 26, by being docked and locked onto it. The refuelling device 26 is in particular a robotic, automatically or semi-automatically operated device. After the refuelling preparations in the refuelling area 24, a refuelling operation 28 takes place. If, because of being heated up, the tank contents reaches a temperature limit value 32, for example 85° C., the refuelling is interrupted. The temperature limit value 32 is determined in the course of a continuous temperature check 30. If a temperature 74 of the tank contents of the at least one hydrogen tank 10 exceeds the temperature limit value 32, the refuelling is interrupted and the vehicle autonomously drives out of the refuelling area 24 to a cooling-down area 36. There, the tank contents of the at least one hydrogen tank 10 are cooled down.

In the cooling-down area 36, cooling-down measures are initiated 38. These may be active cooling-down measures 40 or passive cooling-down measures 42. On the one hand, an active vehicle cooling circuit 65 may be used, on the other hand an external blower 70 could also be used for the cooling down. After cooling down the tank contents of the at least one hydrogen tank 10 to the ambient temperature, the vehicle is once again driven to the refuelling area 24. This may take place autonomously; the vehicle may also be moved by the driver. Renewed performance of a refuelling operation 28 takes place. The refuelling continues until the temperature of the tank contents reaches for example a temperature limit value 32 of 85° C. After that, the vehicle is once again transferred to the cooling-down area 36, which can likewise take place in an autonomous manner. This process may be performed a number of times, until the at least one hydrogen tank 10 is completely filled. This is established by checking whether the pressure within the at least one hydrogen tank 10 lies above a tank pressure limit value.

In the event that the pressure in the at least one hydrogen tank 10 lies in the range of the pressure limit value, a switch is made to the end of refuelling 52 and refuelling is ended; if the tank pressure 76 lies below the permissible tank pressure limit value, the vehicle is once again transferred to the refuelling area 24 and is refuelled again. In the method proposed by the invention, the refuelling of the vehicle does not necessarily have to be ended when a maximum tank pressure of for example 875 bar has been reached for the first time. This pressure value at a temperature of 85° C. corresponds to the nominal pressure of 700 bar at a temperature of 20° C. This positive pressure is allowed in the refuelling process with precooling, i.e. the at least one hydrogen tank is designed and approved for this pressure. As a result of the method proposed by the invention, the tank pressure is for example 700 bar after for example a third cooling-down cycle has been performed (cf. the representation according to FIG. 6) and cooling down has been correspondingly achieved. If a fourth cooling-down cycle follows after that, the pressure within the at least one hydrogen tank 10 can be increased again to 875 bar, with a corresponding increase in temperature. This operation may be repeated a number of times, until 875 bar prevail at the ambient temperature to be expected as a maximum of for example 45° C. As a result, the filling of the at least one hydrogen tank 10 is increased by a factor of (875 bar*293 K/318 K)/700 bar=1.15. This is accompanied by a corresponding increase in the range of the vehicle by 15%.

An additional, further increase in the range of the vehicle is possible if a lower maximum ambient temperature is assumed than the 318 K entered in the above calculation, corresponding to an ambient temperature of for example 45°.

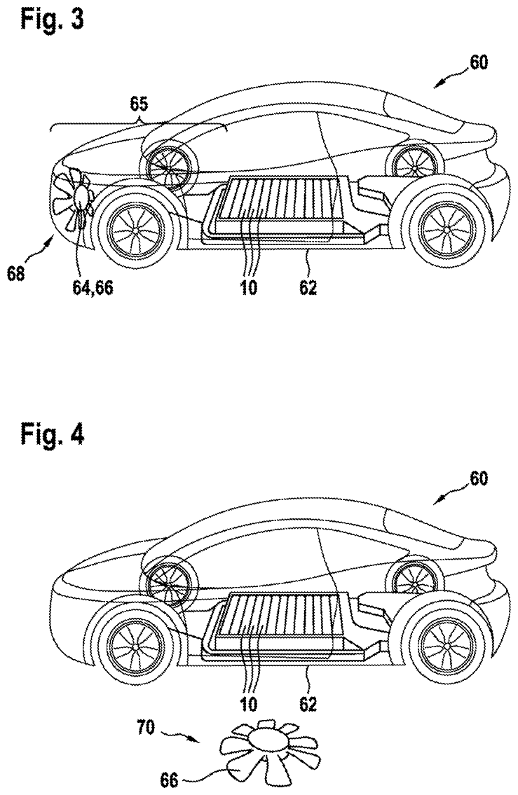

FIG. 3 shows an active cooling measure by means of a vehicle cooling circuit.

In a vehicle 60, which may be an autonomous vehicle 60, the at least one hydrogen tank 10 to be filled is accommodated in the vehicle floor 62. According to the schematic representation in FIG. 3, the vehicle 60 comprises a vehicle cooling circuit 65, which includes a fan 64. As the representation according to FIG. 3 reveals, an active cooling measure 40 takes place here, in that the vehicle cooling circuit 65 is used for cooling the tank contents of the at least one hydrogen tank 10 fitted in the vehicle floor 62.

As an alternative to the representation according to FIG. 3, FIG. 4 shows that the vehicle 60 likewise has at least one hydrogen tank 10 in the vehicle floor 62. This tank is connected to an external blower 70, which is arranged outside the vehicle 60 and may comprise one or more impellers 66, so that external cooling takes place, i.e. an active cooling measure 40 from outside the vehicle 60.

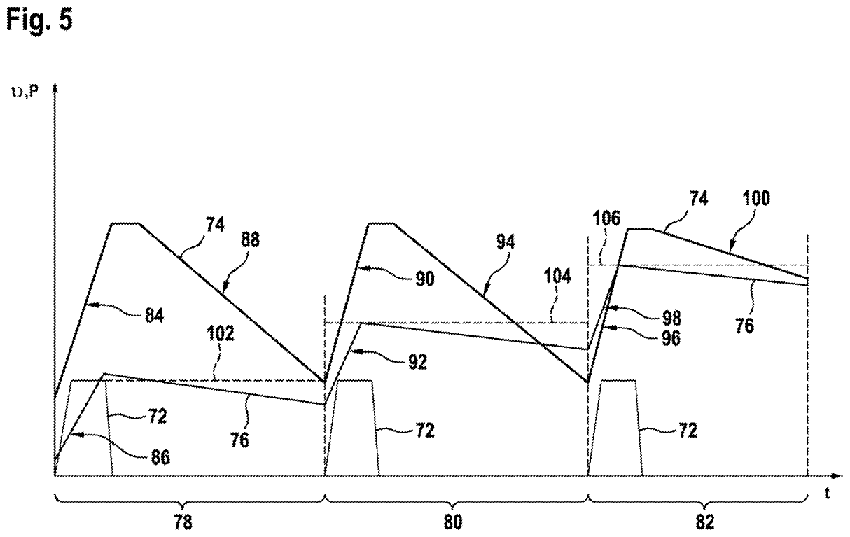

FIG. 5 shows a comparison of a tank temperature profile and a tank pressure profile at at least one hydrogen tank, plotted over the time axis.

As FIG. 5 reveals, the refuelling operation can be divided into a first refuelling phase 78, a then-following second refuelling phase 80 and a third refuelling phase 82. In the representation according to FIG. 6, a hydrogen flow 72, a tank temperature 74 and a tank pressure 76 prevailing within the hydrogen tank 10 are respectively plotted over the time axis.

After initiating the refuelling in the refuelling area 24, a first increase in temperature 84 of the tank contents takes place during the first refuelling operation 28 as a result of the expansion of the hydrogen. This is accompanied by a first increase in tank pressure 86. After completion of the inflow of hydrogen into the water tank 10, a first cooling-down phase 88 takes place within the cooling-down area 36. The cooling down takes place by the initiation of cooling-down measures 38, such as active cooling measures 40 and passive cooling measures 42. Apart from natural convection, the passive cooling measures 42 may also comprise heat conduction.

After the end of the refuelling of the hydrogen tank 10 with gaseous hydrogen, the tank temperature 74 decreases, which takes place during the first cooling-down phase 88. This is accompanied by a decrease in the tank pressure 36. A tank pressure level 102 refers to the tank pressure 76 prevailing in at least one hydrogen tank 10 during the first refuelling phase 78.

The first refuelling phase 78 is followed by a second refuelling phase 80. A second increase in temperature 90 of the tank contents of the at least one hydrogen tank 10 takes place, which is again accompanied by a second increase in pressure 92. After the end of the hydrogen flow 72 during the second refuelling phase 80, a second cooling-down phase 94 takes place, during which the tank contents of the at least one hydrogen tank 10 are cooled down, which takes place by the already mentioned initiation of cooling-down measures 38, whether active cooling measures 40 or passive cooling measures 42. Also in the second refuelling phase 80, a tank pressure level 104 that prevails during the second refuelling phase 80 is reproduced by dashed lines. In the first refuelling phase 78, the temperature of the tank contents increases according to the first increase in temperature 84 for example up to the temperature value of 85° C., while the current tank pressure 76 decreases up to for example 300 bar. After the first cooling-down phase 88 by an active cooling-down measure 40 for example (external blower), the tank contents are cooled down to about 25° C. and this is followed by the second refuelling phase 80. During this, the temperature of the tank contents of the at least one hydrogen tank 10 increases according to the second increase in temperature 90, for example again to 85° C., while the pressure increases to a higher level, to be specific to a pressure level of 600 bar.

During the third refuelling phase 82 according to the representation in FIG. 5, a pressure upper limit is reached (cf. tank pressure level 106 during the third refuelling phase 82); the entire refuelling operation is completed. The vehicle 60 drives away from the filling station; the cooling-down curve (cf. third cooling-down phase 100 during the third refuelling phase 82) follows a much flatter path. At this point in time, no active cooling-down measures 40 are used any longer.

The solution proposed by the invention means that the refuelling of the vehicle 60 is not ended as soon as the maximum tank pressure of 875 bar has been reached for the first time. This pressure value of 875 bar at a temperature of for example 85° C. corresponds to a nominal pressure of 700 bar, which prevails at a temperature of 20° C. This positive pressure, i.e. a Δp of 175 bar, is allowed in the refuelling process with pre-cooling, i.e. the hydrogen tank 10 is designed and approved for this pressure. When the method proposed by the invention is applied, the tank pressure is about 700 bar after the third cooling-down phase 100, i.e. after completion of the third refuelling phase 82. If a fourth refuelling cycle follows after that, the tank pressure can be increased again to a pressure level of 875 bar, which is accompanied by a corresponding increase in temperature. The operation may be repeated a number of times, until a pressure level of 875 bar prevails at the ambient temperature to be expected as a maximum of for example 45° C. In this way, the filling of the tank is increased by a factor of (875 bar*293 K/318 K)/700 bar=1.15, which is accompanied by a corresponding increase in range by 15%.

An additional increase in the range can be achieved if a lower maximum ambient temperature is assumed, which should deviate significantly from the 318 K (45° C.) reproduced in the above relationship.

The invention is not restricted to the exemplary embodiments described here and the aspects highlighted therein. Rather, a multiplicity of modifications that are within the scope of the activities of a person skilled in the art are possible within the range set forth by the claims.

1. A method for refuelling a vehicle (60) with gaseous hydrogen, the vehicle including at least one hydrogen tank (10) integrated in a vehicle floor (62), the method comprising the following method steps:
a) driving the vehicle (60) into a refuelling area (24),
b) performing a refuelling operation (28; 78, 80, 82) on the vehicle (60),
c) performing a first temperature check (30) on the at least one hydrogen tank (10),
d) transferring the vehicle (60) to a cooling-down area (36) if a temperature (74) of the tank contents of the at least one hydrogen tank (10) exceeds a temperature limit value (32),
e) performing a second temperature check (44),
f) performing a tank pressure check (48) if the temperature (74) of the tank contents of the at least one hydrogen tank (10) lies below a temperature limit value (32),
g) making a switch to method step a) if the tank pressure (76) of the at least one hydrogen tank (10) lies below a tank pressure limit value,
h) bringing refuelling to an end (52) if the tank pressure (76) reaches the tank pressure limit value.

2. The method as claimed in claim 1, wherein, according to method step b), the refuelling operation (28; 78, 80, 82) is performed with non-precooled gaseous hydrogen.

3. The method as claimed in claim 1, wherein in order to carry out method step b) a robotic refuelling device (26) is connected to the vehicle (60) in an automatic or semiautomatic manner.

4. The method as claimed in claim 1, wherein, in the cooling-down area (36) according to method step d), active cooling-down measures (40) or passive cooling-down measures (42) for the tank contents of the at least one hydrogen tank (10) are initiated (38).

5. The method as claimed in claim 4, wherein the active cooling-down measures (40) comprise cooling down of the at least one hydrogen tank (10) by a vehicle cooling circuit (65), an internal blower (68) of the vehicle (60) or a blower (70) provided externally of the vehicle (60).

6. The method as claimed in claim 4, wherein the passive cooling-down measures (42) comprise heat dissipation from the at least one hydrogen tank (10) by natural convection and/or heat conduction.

7. The method as claimed in claim 1, wherein, after cooling down of the tank contents of the at least one hydrogen tank (10) to ambient temperature according to method step d) and performing a second tank temperature check (44) according to method step e), the vehicle (60) either drives autonomously to the refilling area (24) once again or is actively driven there and a renewed refuelling operation according to method step b) is performed.

8. The method as claimed in claim 1, wherein, after performing the further refuelling operation (28; 78, 80, 82), when the first temperature value of for example 85° C. of the tank contents of the at least one hydrogen tank (10) is reached, the vehicle (60) is transferred to the cooling-down area (36).

9. The method as claimed in claim 1, wherein method steps a) to e) are performed while a tank pressure check (48) is taking place.

10. The method as claimed in claim 9, wherein, when there is a tank pressure (76) below a tank pressure limit value, a further refuelling operation (28; 78, 80, 82) follows, or, when a tank pressure limit value is reached, the refuelling is completed.

11. The method as claimed in claim 1, wherein method steps a) to h) are discontinued after a defined time period (“timeout”) or when a time of day has passed or when an instruction that the vehicle is to be used with immediate effect is received, even if method step h) has not yet been reached.

12. The use of the method as claimed in claim 1 for refuelling an autonomous or non-autonomous vehicle (60) with fuel-cell drive and at least one hydrogen tank (10) that can be filled with gaseous hydrogen.
